(19) United States
(12) Patent Application Publication
(10) Pub. No.: US 2022/0064534 A1
(43) Pub. Date: Mar. 3, 2022

(54) ORGANIC MATTER DEGRADATION DEVICE AND ORGANIC MATTER DEGRADATION METHOD

(71) Applicant: HUI-HSIUNG LEE, TAIPEI CITY (TW)

(72) Inventor: HUI-HSIUNG LEE, TAIPEI CITY (TW)

(21) Appl. No.: 17/069,088

(22) Filed: Oct. 13, 2020

(30) Foreign Application Priority Data
Aug. 28, 2020 (TW) 109129656

(51) Int. Cl. C10B 19/00; C10B 29/02

(52) U.S. Cl. CPC C10B 19/00; C10B 29/02

(57) ABSTRACT

An organic matter degradation device has a reaction chamber which sidewall includes at least one energy resonance/reflection/storage unit made of an infrared material. An excess heat energy of each degradation is reflected by the infrared material, and the excess heat energy and a heat energy radiated from the infrared material propagate to the non-degraded organic matter in the housing space of the reaction chamber, again, so as to continue the degradation of the organic matter. The organic matter degradation device has active heat radiation to present main advantages of uniform heat effect, low energy consumption and fast degradation time. The heat energy is accumulated after several times, and thus the degradation of the organic matter continues without using the initial heating device to continuously provide the subsequent heat energy. The present disclosure further provides an organic matter degradation method.

### TECHNICAL FIELD

The present disclosure relates to a degradation device and degradation method, in particular to, a degradation device for processing an organic matter and an organic matter degradation method.

### RELATED ART

For the current marketed degradation device, such as, a volume reduction device disclosed in TW Patent TWI698292, a reaction chamber is mainly stacked with an organic matter therein, and it slowly and simultaneously performs a drying, carbonization and ashing steps on the organic matter. Since the reaction chamber does not have a chimney that diffuses exhaust gas into the atmosphere, to achieve the drying, carbonization and ashing of the organic matter, an exhaust pipe for removing exhaust gas from a top space of the reaction chamber is disposed, and a post process for processing the exhaust gas is required. In order to keep the steps of drying, carbonization and ashing at the lower end of the organic matter for a long time, a low-oxygen gas supply method is adopted. The gas supply method is for example illustrated by CN Patent CN104456574B, an air supply mechanism is equipped for supplying air to the reaction chamber, wherein the air supply mechanism has a blower to blow air to the main pipe and multiple branch pipes that branch from the main pipe in its length direction and blow air into the reaction chamber.

Regarding the drying, carbonization and ashing at the lower end of the organic matter, TW Patent Application TW200602134 discloses a powdery ceramic layer, a charcoal layer, a sawdust layer and an organic waste layer are stacked on the bottom plate of the reaction chamber in sequence, the charcoal layer is used to pre-heat the powdery ceramic layer to make the powdery ceramic layer store heat and achieve thermal radiation effect. However, the powdery ceramic layer merely stores the heat, and the powdery ceramic layer achieves the thermal radiation effect after storing the heat. As stated by the above TW Patent Application, when the residue is discharged, the powdery ceramic layer must be scraped out, and the thickness of the remaining powdery ceramic layer must be controlled. In other words, when using the reaction chamber next time, it is necessary to consider the layer thickness of the powdery ceramic layer left before, and then re-lay the powdery ceramic layer. Obviously, this causes trouble and inconvenience in operation. For example, it may be time-consuming and wasteful to measure the thickness of the powdery ceramic layer at different positions with a ruler every time, and then the powdery ceramic layer is smoothed back and forth several times with a scraper, and then the powdery ceramic to be added is calculated. After adding the powdery ceramic, the powdery ceramic layer is scraped back and forth repeatedly with a scraper several times to make the heat radiation present a uniform thermal effect on the organic waste layer.

TW Patent Application TW200602134 discloses a heat source that merely from the powdery ceramic layer and the charcoal layer on bottom of the reaction chamber. However, in an actual operation, the thickness of the organic waste layer is much larger than the thicknesses of the ceramic layer and the charcoal layer. The thermal energy for degrading organic waste can only be gradually transferred from the powdery ceramic layer and charcoal layer at the bottom of the reaction chamber to the upper organic waste layer. The person with the ordinary skill in the art knows that the heat transfer effect of organic waste is very poor, so this makes it take a very long time for the technology of TW200602134 to transform the entire organic waste layer into a carbonized layer. Further, in the process, the heat energy transferred from the powdery ceramic layer and charcoal layer to the upper layer will also escape from the wall of the reaction chamber to the outside of the reaction chamber, which in turn makes the heat energy generated by the powdery ceramic layer and the charcoal layer unable to be effectively used and wasted.

### SUMMARY

An objective of the present disclosure is to provide an organic matter degradation device and an organic matter degradation method, wherein the organic matter degradation device and the organic matter degradation method have active heat radiation to present main advantages of uniform heat effect, low energy consumption and fast degradation time.

To achieve the above objective of the present disclosure, an organic matter degradation device is provided. The organic matter degradation device at least comprises a reaction chamber, the reaction chamber comprises a hearth, a sidewall and a top cover, two ends of the sidewall respectively connects with the hearth and the top cover, and the hearth, the sidewall and the top cover together form a housing space. The sidewall at least comprises an energy resonance/reflection/storage unit, and the energy resonance/reflection/storage unit is made of an infrared material.

According to the organic matter degradation device, the infrared material is a far infrared material.

According to the organic matter degradation device, the far infrared material comprises a far infrared reflective material and a far infrared radiation material.

According to the organic matter degradation device, an inner surface of the sidewall is formed by the energy resonance/reflection/storage unit.

According to the organic matter degradation device, from the inside out, the energy resonance/reflection/storage unit is formed by stacking a far infrared radiation layer made of the far infrared radiation material and a far infrared reflective layer made of the far infrared reflective material.

According to the organic matter degradation device, the far infrared material further comprises a thermal insulation material, from the inside out, the energy resonance/reflection/storage unit is formed by stacking a far infrared radiation layer made of the far infrared radiation material, a far infrared reflective layer made of the far infrared reflective material and a thermal insulation layer made of the thermal insulation material.

According to the organic matter degradation device, the far infrared reflective material and/or the far infrared radiation material are non-metal materials.

According to the organic matter degradation device, the far infrared reflective material at least one selected from a group comprising ZrC, TiC, TaC, MoC, WC, B₄C, SiC, TiSi₂, WSi₂, MoSi₂, ZrB₂, TiB₂, CrB₂, ZrN, TiN, AlN and Si₃N₄.

According to the organic matter degradation device, the far infrared radiation material is at least one selected from a group comprising MgO, CaO, BaO, ZrO₂, TiO₂, Cr₂O₃, MnO₂, Fe₂O₃, Al₂O₃, Ta, Mo, W, Fe, Ni, Pt, Cu and Au.

According to the organic matter degradation device, the far infrared reflective material is SiC, and the far infrared radiation material is MgO.

According to the organic matter degradation device, the far infrared material further comprises a thermal insulation material, and the thermal insulation material is a lightweight porous inorganic material.

According to the organic matter degradation device, the far infrared radiation material is powder, a particle diameter of the far infrared radiation material is not larger than 14 μm, preferably, 0.4 through 14 μm, a number average particle diameter of the far infrared radiation material is 3.83 μm, the particle diameter of the 99% far infrared radiation material is not larger than 11.85 μm, and an average far infrared radiation coefficient of the far infrared radiation material is not less than 0.98.

To achieve the above objective of the present disclosure, the present disclosure further provides an organic matter degradation method comprising sequential steps as follows: an organic matter degradation device providing step, wherein the above organic matter degradation device and an initial heating device are provided, and the initial heating device is disposed on the sidewall or the hearth; an organic matter stacking step, wherein an organic matter is stacked on the housing space; a heat source providing step, wherein the initial heating device is opened for a predetermined period; a heat source closing step, wherein the initial heating device is closed after the initial heating device has been opened for the predetermined period; a degradation continuing step, wherein after closing the initial heating device, the far infrared reflective material of the energy resonance/reflection/storage unit which forms the sidewall reflects a heat energy generated by a degradation of the organic matter in the housing space to the housing space, so as to provide a required heat energy for the degradation of the organic matter, again, and the heat energy reflected to the housing space and a far infrared heat energy radiated from the far infrared radiation material are provided to the organic matter in housing space for continuing the degradation; and a degradation finishing step, wherein a condition of the housing space is observed until the degradation of the organic matter is determined to be finished or to a predetermined degradation level.

### BRIEF DESCRIPTIONS OF DRAWINGS

FIG. 1 is a schematic diagram showing a whole structure of an organic matter degradation device of the present disclosure.

FIG. 2 is a schematic sectional diagram showing a reaction chamber of an organic matter degradation device of the present disclosure.

FIG. 3 is a first schematic diagram showing a structure of a sidewall of an organic matter degradation device of the present disclosure.

FIG. 4 is a second schematic diagram showing a structure of a sidewall of an organic matter degradation device of the present disclosure.

FIG. 5 is a third schematic diagram showing a structure of a sidewall of an organic matter degradation device of the present disclosure.

FIG. 6 is a flow chart of an organic matter degradation method of the present disclosure.

FIG. 7 is a three dimensional schematic diagram of an organic matter degradation device of the present disclosure, which has an air supply unit and a negative ion generating unit.

FIG. 8 is a schematic diagram of a structure of an organic matter degradation device of the present disclosure, which is installed with a negative ion generating unit.

FIG. 9 is a schematic diagram showing a structure of an organic matter degradation device of the present disclosure, which negative ion generating unit has a coil module.

### DETAILED DESCRIPTIONS OF EMBODIMENT

Embodiments of the present disclosure will now be described, by way of example only, with reference to the accompanying drawings. The following drawings are dedicated for description, and they are schematic and exemplary, being not drawn and precisely allocated in accordance with the actual ratio, thus not limiting the present disclosure.

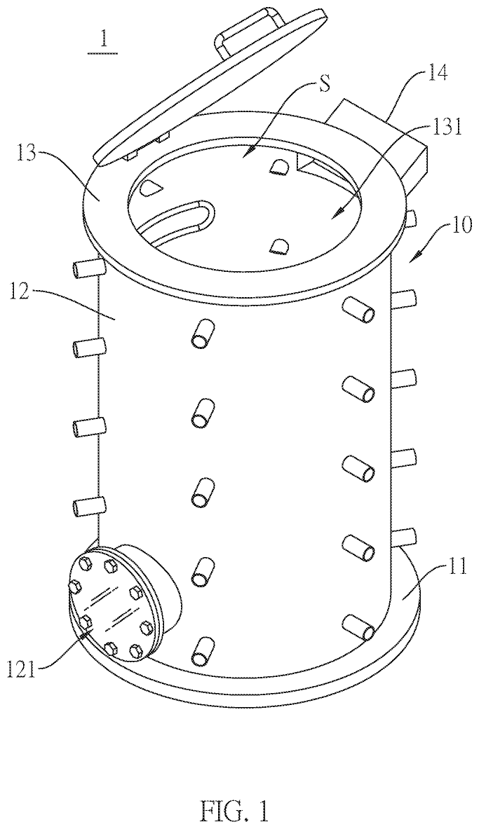

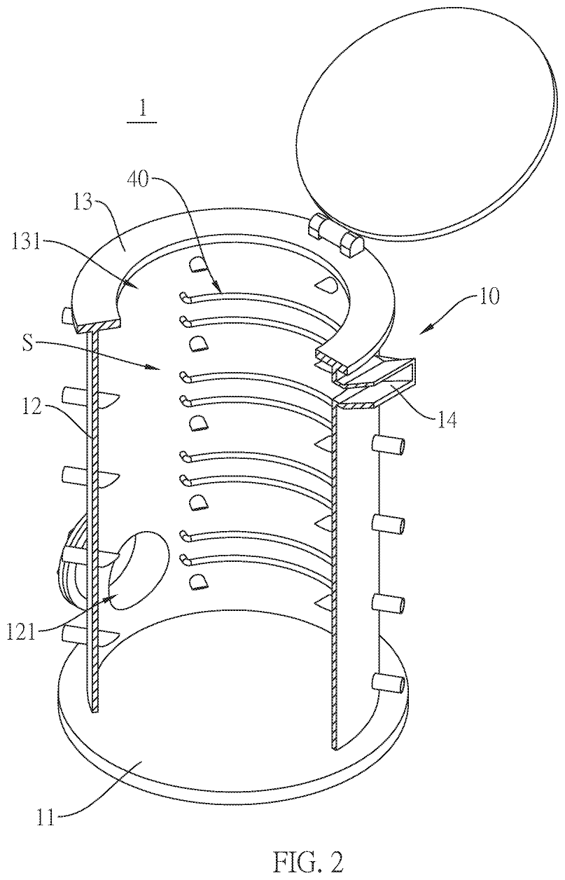

Firstly, refer to FIG. 1 and FIG. 2, an organic matter degradation device (1) at least comprises a reaction chamber (10) and an initial heating device (40). The reaction chamber (10) comprises a hearth (11), a sidewall (12) and a top cover (13), two ends of the sidewall (12) respectively connects with the hearth (11) and the top cover (13), and the hearth (11), the sidewall (12) and the top cover (13) together form a housing space (S). The organic matter (not shown in the drawings) stacks in the housing space (S). The sidewall (12) can be a hollow cylinder, such as a circle hollow cylinder, hollow elliptic cylinder, hollow cuboid or hollow cube, or hollow circular cylinder with any shape in cross section. Of course, the sidewall (12) is installed with an observing window (121), and the observing window (121) is sealed with a transparent material (such as glass or quartz) to ensure that outside air will not enter the housing space (S) from the observing window (121) and destroy the reaction environment of organic matter degradation. The window (121) allows the operator to observe the status of the housing space (S). The top cover (13) is installed with an entrance (131), and the entrance (131) is communicative to the housing space (S) and the outside environment. During operation, the door of the entrance (131) can be opened firstly to allow the organic matter to be put into the housing space (S) through the entrance (131), and then the door of the entrance (131) is closed to ensure that outside air will not enter the housing space (S) through the entrance (131) and destroy the reaction environment. The organic matter degradation device (1) also include an exhaustion hole (14) that is communicative to the housing space (S) with the outside or an exhaust gas treatment device (not shown in the drawings), and the exhaustion hole (14) can be arranged on the sidewall (12) or the top cover (13). During operation, the exhaustion hole (14) discharges the exhaust gas generated by the reaction chamber (10) to the outside or the exhaust gas treatment device.

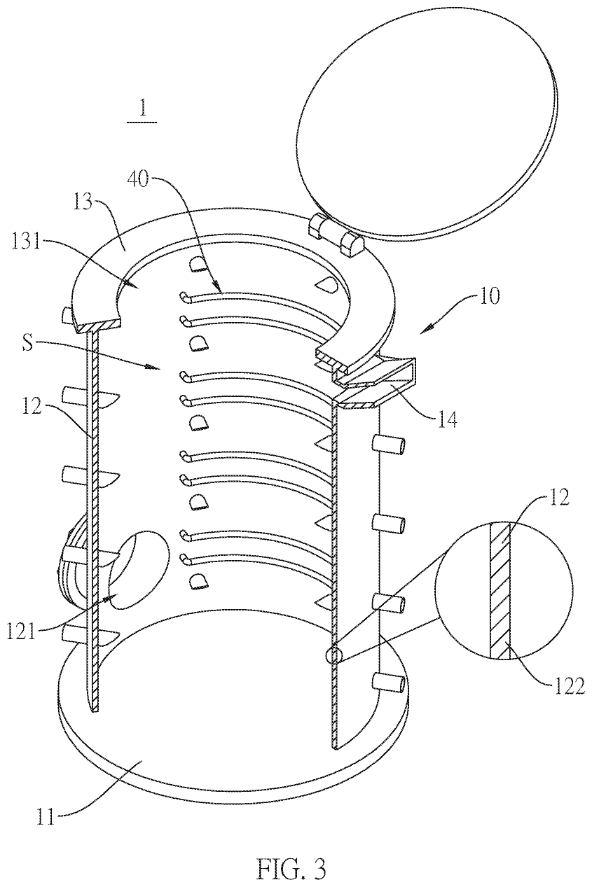

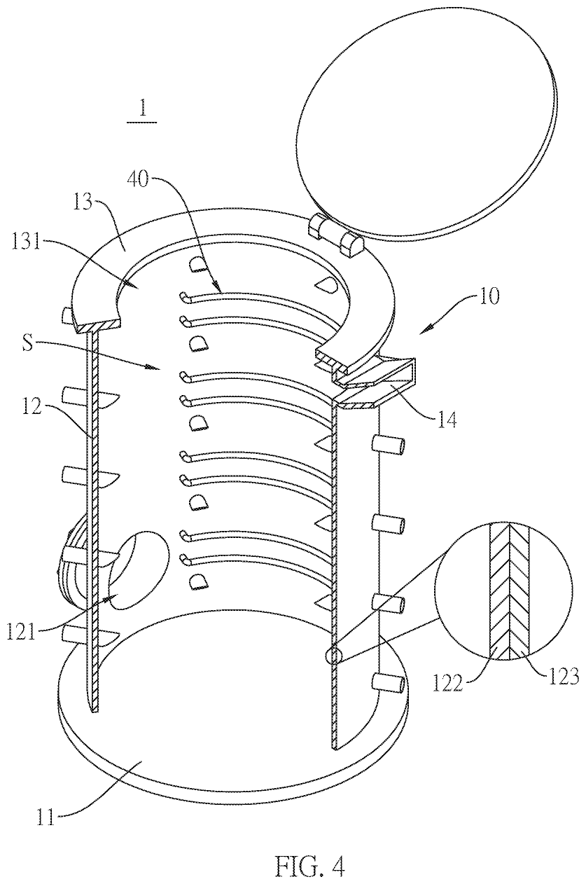

Refer to FIG. 3 and FIG. 4, the sidewall (12) at least comprises an energy resonance/reflection/storage unit (122), the sidewall (12) is entirely formed by the energy resonance/reflection/storage unit (122) (see FIG. 3); or alternatively, the sidewall (12) can be formed by a support layer (123) and an inner surface of the sidewall (12), the inner surface of the sidewall (12) is attached to the support layer (123), and the inner surface of the sidewall (12) is formed by the energy resonance/reflection/storage unit (122) (see FIG. 4). For example, the energy resonance/reflection/storage unit (122) is made of an infrared material, the infrared material can release an infrared light having a wavelength being 0.78 μm to 1000 and the sidewall (12) is made of the infrared material, or alternatively, an inner surface of the sidewall (12) is made of the infrared material. The inner surface of the sidewall (12) is a surface layer of the housing space (S). In other words, the inner surface of the sidewall (12) contacts the organic matter during the degradation. Preferably, the infrared material can be a far infrared material, and the far infrared material can release a far infrared light having a wavelength being 8 μm to 12 The far infrared material includes a far infrared reflective material, a far infrared radiation material and a thermal insulation material. The far infrared reflective material is non-oxide inorganic material. The far infrared reflective material at least one selected from a group comprising ZrC, TiC, TaC, MoC, WC, B₄C, SiC, TiSi₂, WSi₂, MoSi₂, ZrB₂, TiB₂, CrB₂, ZrN, TiN, AN and Si₃N₄. The far infrared radiation material is metal oxide, and the far infrared radiation material is at least one selected from a group comprising MgO, CaO, BaO, ZrO₂, TiO₂, Cr₂O₃, MnO₂, Fe₂O₃, Al₂O₃, Ta, Mo, W, Fe, Ni, Pt, Cu and Au. Or alternatively, the far infrared radiation material is a metal material, the far infrared radiation material at least one selected from a group comprising Ta, Mo, W, Fe, Ni, Pt, Cu and Au. The far infrared radiation material can release a far infrared light having a wavelength being 8 μm to 12 μm. The thermal insulation material can be a lightweight porous inorganic material, such as, zeolite. Preferably, the far infrared reflective material is SiC, the far infrared radiation material is MgO, and the thermal insulation material is zeolite. The far infrared reflective material reflects a heat energy generated by a degradation of the organic matter in the housing space (S) to the housing space (S), so as to provide the required heat energy for the degradation of the organic matter, again. The heat energy reflected to the housing space (S) and a far infrared heat energy radiated from the far infrared radiation material are provided to the organic matter in housing space (S) for continuing the degradation, and that is, the “energy resonance” is formed to have the advantages of uniform heat effect and fast degradation time. The thermal insulation material is used to prevent heat energy from escaping from the housing space (S) to the external environment, so that, due to the aforementioned “energy resonance” and the thermal insulation effect of the thermal insulation material, the entire organic matter degradation device (1) can close the initial heating device (40) during the organic matter degradation process to achieve low energy consumption.

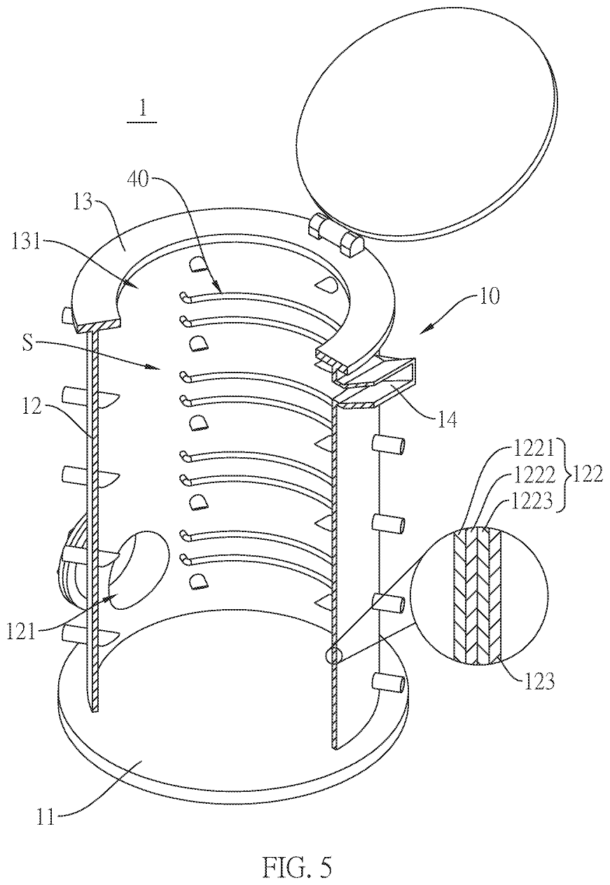

The far infrared radiation material is powder, a particle diameter of the far infrared radiation material is not larger than 14 μm, preferably, 0.4 to 14 μm, a number average particle diameter of the far infrared radiation material is 3.83 μm, the particle diameter of the 99% far infrared radiation material is not larger than 11.85 μm, and an average far infrared radiation coefficient of the far infrared radiation material is not less than 0.98. In the present invention, the number average particle diameter be calculated from an image observed under a field emission scanning electron microscope (FE-SEM) or a transmission electron microscope (TEM). Specifically, the number average particle diameter may be obtained as an arithmetic average value by extracting several samples from the image observed with the FE-SEM or TEM, and measuring diameters of these samples. When making the energy resonance/reflection/storage unit (122), the far infrared reflective material, the far infrared radiation material and the thermal insulation material can be selectively mixed with an adhesive (such as inorganic adhesive, inorganic ceramic powder), and then sintered. Or as shown in FIG. 5, from the inside out, the energy resonance/reflection/storage unit (122) is formed by stacking a far infrared radiation layer (1221) made of the far infrared radiation material, a far infrared reflective layer (1222) made of the far infrared reflective material and a thermal insulation layer (1223) made of the thermal insulation material. The thermal insulation layer (1223) stacks on the inner side of the support layer (123).

Refer to FIG. 2 again, the initial heating device (40) can be disposed on the sidewall (12) or the hearth (11), and preferably, the initial heating device (40) is disposed on the sidewall (12). The initial heating device (40) can be an electric heater, a hot air supply device, a charcoal fire, or other heat sources to provide the required heat energy at the initial stage of the organic matter degradation.

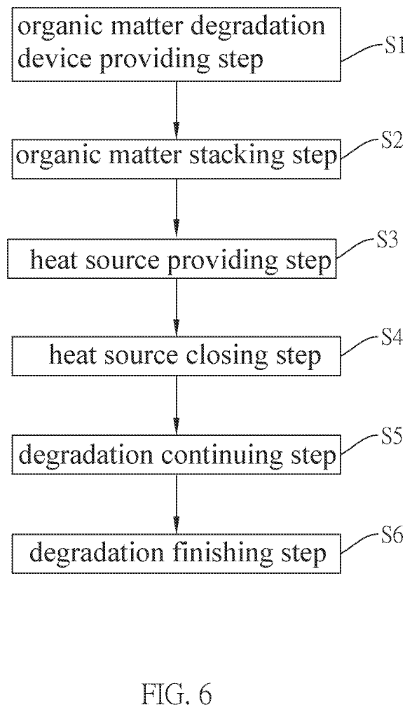

Refer to FIG. 6, the organic matter degradation device (1) uses an organic matter degradation method to degrade the organic matter. The organic matter degradation method includes the following steps in sequence.

An organic matter degradation device providing step (S1): providing the above organic matter degradation device (1).

An organic matter stacking step (S2): stacking an organic matter on the housing space (S), for example, the organic matter is put into the housing space (S) through the entrance (131), and next, the door of the entrance (131) is closed to ensure that outside air will not enter the housing space(S) through the entrance (131) and destroy the reaction environment.

A heat source providing step (S3): opening the initial heating device (40) for a predetermined period, the initial heating device (40) is for example an electric heater, and the initial heating device (40) can provide an initial degradation heat energy, the initial degradation heat energy is for example provided as the activation energy to break the carbon-hydrogen bond (bond energy about 100 Kcal/mol) of the organic matter, and for another example, the initial degradation heat energy is provided as the activation energy for flameless combustion reaction (also called fumigation or low-oxygen combustion). Since the fumigation is an exothermic reaction, the energy (heat energy) released by the exothermic reaction is more than the initial degradation heat energy used to provide the activation energy for the fumigation reaction, so the excess heat energy will propagate to the energy resonance/reflection/storage unit (122) of the sidewall (12) in FIG. 5. The initial heating device (40) is opened for a predetermined period.

A heat source closing step (S4): after the initial heating device (40) has been opened for the predetermined period, closing the initial heating device (40).

A degradation continuing step (S5): the excess heat energy propagates to the energy resonance/reflection/storage unit (122) of the sidewall (12) in FIG. 5, wherein after the excess heat energy is reflected by the far infrared reflective layer (1222), the heat energy reflected to the housing space (S) and a far infrared heat energy radiated from the far infrared radiation layer (1221) propagate to the non-degraded organic matter in the housing space (S) for continuing the degradation of the organic matter. The excess heat energy of each degradation is reflected by the far infrared reflective layer (1222), and the excess heat energy and a heat energy radiated from the far infrared radiation layer (1221) propagate to the non-degraded organic matter in the housing space (S), again, so as to continue the degradation of the organic matter. The thermal insulation layer (1223) can reduce or prevent heat dissipation from the housing space (S) to the outside, and since the far infrared reflective layer (1222) is arranged on the outside of the far infrared radiation layer (1221), it can further ensure that the heat energy released by the far infrared radiation layer (1221) is reflected by the far infrared reflective layer (1222), and can propagate inward to the non-degraded organic matter in the housing space (S). The heat energy is accumulated after several times, and thus the degradation of the organic matter continues (i.e. chain reaction) without using the initial heating device (40) to continuously provide the subsequent heat energy. In other words, as mentioned above, After closing the initial heating device (40), by using the energy resonance/reflection/storage unit (122) of the sidewall (12), the far infrared reflective material reflects the heat energy generated by the organic matter degradation in the housing space(S) back to the housing space (S), so as to provide the required heat energy of the organic matter for degradation. The heat energy reflected to the housing space (S) and the far infrared heat energy radiated from the far infrared radiation material are provided to the organic matter in housing space (S) for continuing the degradation, and that is, the “energy resonance” is formed to have the advantages of uniform heat effect and fast degradation time. The thermal insulation material is used to prevent heat energy from escaping from the housing space (S) to the external environment, so that, due to the aforementioned “energy resonance” and the thermal insulation effect of the thermal insulation material, the entire organic matter degradation device (1) can close the initial heating device (40) during the organic matter degradation process to achieve low energy consumption.

A degradation finishing step (S6): observing a condition of the housing space (S) by using the observing window (121) until the degradation of the organic matter is determined to be finished or to a predetermined degradation level.

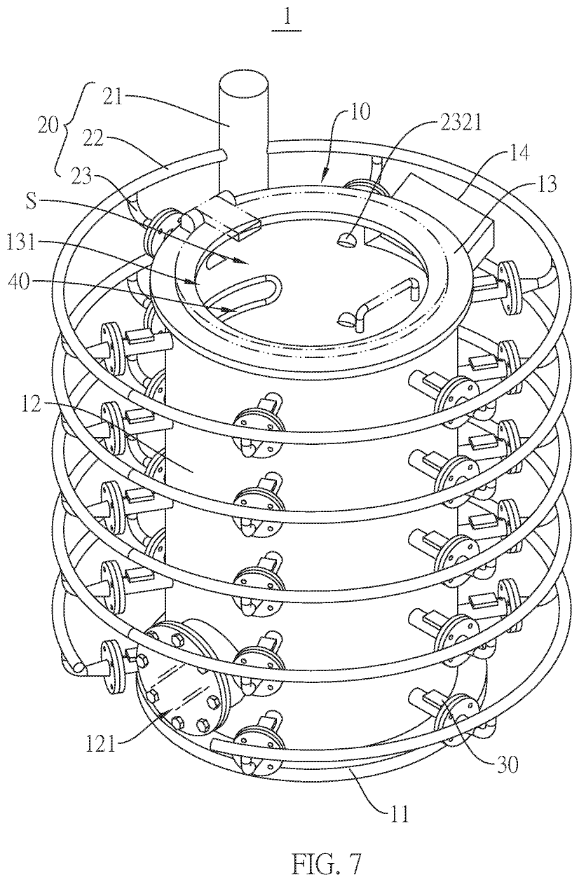

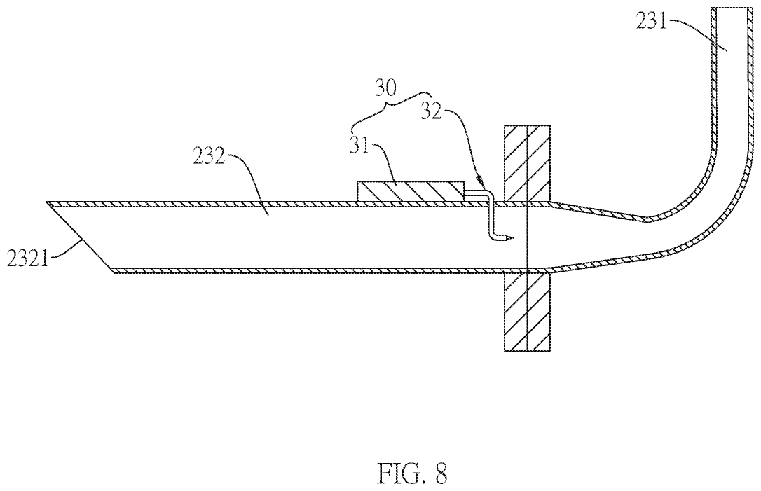

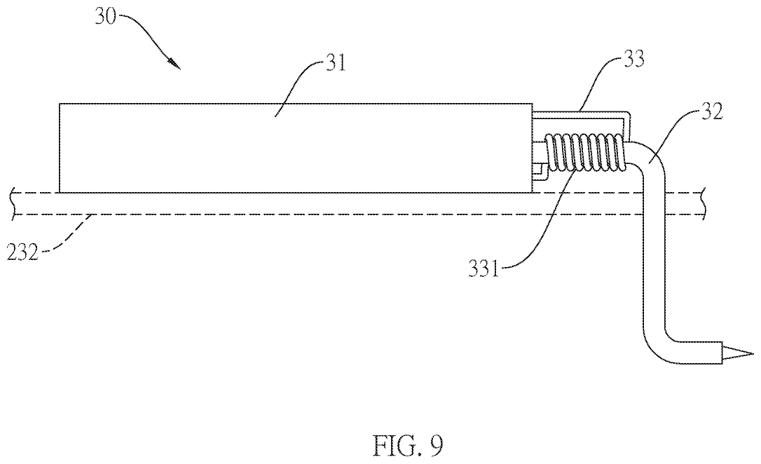

Refer to FIG. 7 to FIG. 9, the organic matter degradation device (1) further comprises an air supply unit (20) and a negative ion generating unit (30). The air supply unit (20) is composed of a bellows (21), a plurality of air pipes (22) and a plurality of branch pipes (23). The bellows (21) is disposed on the outside of the reaction chamber (10), and roughly in the shape of a cylinder. The bellows (21) is arranged axially along the height direction of the reaction chamber (10), and the bellows (21) supplies gas to the air pipe (22) and the branch pipes (23) by using a blower. Furthermore, the air supply unit (20) includes a plurality of air pipes (22) that surround the reaction chamber (10) and are arranged in parallel from top to bottom, wherein the air pipes (22) are respectively connected to the bellows (21), to receive the gas from the bellows (21). Moreover, The air pipe (22) is connected to the reaction chamber (10) through 12 branch pipes (23), that is, the two ends of the branch pipe (23) are connected to the air pipe (22) and the housing space (S) of the chamber (10), so that the gas from the bellows (21) enters the housing space (S) after passing through the air pipe (22) and the branch pipe (23). The branch pipe (23) is composed of a first sub-pipe (231) arranged vertically and a second sub-pipe (232) arranged horizontally. In other words, the first sub-pipe (231) and the second sub-pipe (232) are arranged perpendicular to each other. The two ends of the first sub-pipe (231) are respectively connected to the air pipe (22) and the second sub-pipe (232), and the two ends of the second sub-pipe (232) are respectively connected to the housing space (S) of the reaction chamber (10) and the first sub-pipe (231). The air outlet (2321) of the second sub-pipe (232) which is connected to the housing space (S) of the reaction chamber (10) is an oblique outlet. The negative ion generating unit (30) is arranged at one end of the branch pipe (23), for example: the negative ion generating unit (30) is set on the first sub-pipe (231) arranged vertically, or the negative ion generating unit (30) is set on the second sub-pipe (232) arranged horizontally; preferably, the negative ion generating unit (30) is set on the second sub-pipe (232) arranged horizontally, so that the negative ions directly enter the reaction chamber (10), so that the resistance applied to the negative ions generated by the negative ion generating unit (30) can be efficiently avoided. The negative ion generating unit (30) includes a circuit module (31) and a wire module (32) connected to the circuit module (31). The circuit module (31) for generating a plurality of electrons is composed of a circuit board (not shown in the drawings), a trigger circuit (not shown in the drawings), a transformer (not shown in the drawings) and a rectifier circuit (not shown in the drawings), wherein the trigger circuit, the transformer, and the rectifier circuit are separately disposed on the circuit board, and electrically connected to the circuit board, wherein the circuit board is electrically connected to a power source (not shown in the drawings) to provide the power received from the power source to the trigger circuit, the transformer and the rectifier circuit as the required power when operating. An end of the wire module (32) away from the circuit module (31) extends into the second sub-pipe (232) of the branch pipe (23) and generates negative ions in the form of sharp discharge. The negative ion generating unit (30) includes a coil module (33) arranged outside the wire module (32), and a part of the coil module (33) forms a loop part (331) and is arranged around the outside of the wire module (32), for example, the loop part (331) is set in the front section of the wire module (32), and the coil module (33) is electrically connected to the circuit module (31) or the power supply.

Accordingly, compared to the prior art, the organic matter degradation device and the organic matter degradation method of the present disclosure have the following advantages. The far infrared reflective material reflects the heat energy of the organic matter degradation in the housing space to the housing space to provide the required heat energy of the organic matter for degradation. The heat energy reflected to the housing space and the far infrared heat energy radiated from the far infrared radiation material are provided to the organic matter in housing space for continuing the degradation, and that is, the “energy resonance” is formed to have the advantages of uniform heat effect and fast degradation time. The thermal insulation material is used to prevent heat energy from escaping from the housing space to the external environment, so that, due to the aforementioned “energy resonance” and the thermal insulation effect of the thermal insulation material, the entire organic matter degradation device can close the initial heating device during the organic matter degradation process to achieve low energy consumption.

To sum up, the organic matter degradation device and the organic matter degradation method of the present disclosure is indeed disclosed by the descriptions of different embodiments, and they can achieve the desired result(s). Furthermore, the organic matter degradation device and the organic matter degradation method of the present disclosure are not anticipated and obtained by the prior art, and the present disclosure complies with the provision of the patent act. The present disclosure is applied according to the patent act, and the examination and allowance requests are solicited respectfully.

Although particular embodiments of the present disclosure have been described in detail for purposes of illustration, various modifications and enhancements may be made without departing from the spirit and scope of the present disclosure. Accordingly, the present disclosure is not to be limited except as by the appended claims.

1. An organic matter degradation device, comprising: a reaction chamber, the reaction chamber comprises a hearth, a sidewall and a top cover, wherein two ends of the sidewall respectively connects with the hearth and the top cover, and the hearth, the sidewall and the top cover together form a housing space; and wherein the sidewall comprises an energy resonance/reflection/storage unit, and the energy resonance/reflection/storage unit is made of a far infrared radiation material and a far infrared reflective material; wherein the far infrared reflective material is at least one selected from a group consisting of ZrC, TiC, TaC, MoC, WC, B₄C TiSi₂, WSi₂, MoSi₂, ZrB₂, TiB₂, CrB₂, ZrN, TiN, MN and Si₃N₄, and the far infrared radiation material is at least one selected from a group consisting of BaG, ZrO₂, TiO₂, Cr₂O₃, MnO₂, Ta, Mo, W, Fe, Ni, Pt, Cu and Au; and wherein the energy resonance/reflection/storage unit is further made of far infrared material further comprises a thermal insulation material, wherein from an inside out, the energy resonance/reflection/storage unit is formed by stacking the far infrared radiation layer made of the far infrared radiation material, the far infrared reflective layer made of the far infrared reflective material and a thermal insulation layer made of the thermal insulation material.

2. (canceled)

3. (canceled)

4. The organic matter degradation device according to claim 1, wherein an inner surface of the sidewall is formed by the energy resonance/reflection/storage unit.

5. The organic matter degradation device according to claim 1, wherein from the inside out, the energy resonance/reflection/storage unit is formed by stacking a far infrared radiation layer made of the far infrared radiation material and a far infrared reflective layer made of the far infrared reflective material.

6. (canceled)

7. The organic matter degradation device according to claim 1, wherein the far infrared reflective material is a non-oxide inorganic material, and the far infrared radiation material is a metal oxide or non-metal material.

8. (canceled)

9. (canceled)

10. (canceled)

11. The organic matter degradation device according to claim 1, wherein the thermal insulation material is a zeolite.

12. The organic matter degradation device according to claim 5, wherein the far infrared radiation material is powder which is sintered to form the far infrared radiation layer, a particle diameter of the far infrared radiation material is not larger than 14 μm, a number average particle diameter of the far infrared radiation material is 3.83 μm, the particle diameter of the 99% far infrared radiation material is not larger than 11.85 μm, and an average far infrared radiation coefficient of the far infrared radiation material is not less than 0.98.

13. An organic matter degradation method, comprising sequential steps as follows:
an organic matter degradation device providing step: providing an organic matter degradation device and an initial heating device, wherein the organic matter degradation device comprises: a reaction chamber, the reaction chamber comprises a hearth, a sidewall and a top cover, wherein two ends of the sidewall respectively connects with the hearth and the top cover, and the hearth, the sidewall and the top cover together form a housing space; wherein the sidewall comprises an energy resonance/reflection/storage unit, and the energy resonance/reflection/storage unit is made of a far infrared radiation material, a far infrared reflective material and a thermal insulation material, wherein the initial heating device is disposed on the sidewall or the hearth, and is an electric heater, a hot air supply device or a charcoal fire;
an organic matter stacking step: stacking an organic matter in the housing space;
a heat source providing step: opening the initial heating device for a predetermined period;
a heat source closing step: after the initial heating device has been opened for the predetermined period, closing the initial heating device;
a degradation continuing step: after closing the initial heating device, the far infrared reflective material of the energy resonance/reflection/storage unit which forms the sidewall reflects a heat energy generated by a degradation of the organic matter in the housing space to the housing space, so as to provide a required heat energy for the degradation of the organic matter, again; the heat energy reflected to the housing space and a far infrared heat energy radiated from the far infrared radiation material are provided to the organic matter in housing space for continuing the degradation; and
a degradation finishing step: observing a condition of the housing space until the degradation of the organic matter is determined to be finished or to a predetermined degradation level.
